(19) United States
(12) Patent Application Publication
(10) Pub. No.: US 2013/0302235 A1
(43) Pub. Date: Nov. 14, 2013

(54) REMOVING SULFUR DIOXIDE FROM PACKAGING

(71) Applicant: MULTISORB TECHNOLOGIES, INC., Buffalo, NY (US)

(72) Inventors: George E. McKedy, Williamsville, NY (US); Thomas H. Powers, Mayville, NY (US)

(21) Appl. No.: 13/830,470

(22) Filed: Mar. 14, 2013

Related U.S. Application Data
(63) Continuation-in-part of application No. 13/469,919, filed on May 11, 2012.

(51) Int. Cl. B01J 20/10; B65D 81/24; B01J 20/20

(52) U.S. Cl. CPC B01J 20/103; B01J 20/20; B65D 81/24
USPC 423/244.01; 252/184; 206/524.4; 426/124

(57) ABSTRACT

A sulfur dioxide reducing composition for reducing the headspace concentration of sulfur dioxide in fruit packages includes a sulfur dioxide absorber having pores sized to retain sulfur dioxide therein and a clinching absorber on the sulfur dioxide absorber with which the sulfur dioxide reacts irreversibly with the sulfur dioxide.

### CROSS-REFERENCE TO RELATED APPLICATIONS

The present application is a continuation-in-part of pending U.S. application Ser. No. 13/469,919 filed May 11, 2012, the entire disclosure of which is expressly incorporated by reference.

### BACKGROUND OF THE INVENTION

1. Field of the Invention

This invention relates to sulfur dioxide reduction. More specifically, the invention relates to a composition for removing sulfur dioxide from a headspace of a container containing fruit or any other product preserved with sulfur dioxide.

2. Description of Related Art

Sulfur dioxide has been used as a gaseous antimicrobial for over 80 years. For example, it has been used in the grape industry by gassing on the fruit before picking to control the growth of the fungus Botrytis Cinerea, which causes gray mold, and as a bleaching agent, to produce golden color grapes. Without sulfur dioxide fumigation the long term storage of table grapes would not be possible.

Dried fruits, such as apricots, also are subjected to sulfur dioxide treatment during the drying process to inhibit the Maillard reaction between amino acids and sugars in the fruit. More specifically, the Maillard reaction is between the reactive carbonyl group of the sugars and the nucleophilic amino group of the amino acid and results in a range of odors and off-flavors. This reaction is also responsible for the browning of fruit after the fruit is cut. The process of gassing fruit with sulfur dioxide on the vine to inhibit the Maillard reactions extends the shelf of dried fruits allowing for the long shelf life that we have today.

Golden raisins, dried apricots, dried peaches, dried pears, and others are generally harvested once per year, and gassed with sulfur dioxide while fresh, either before or after picking, to enhance color and stop the Maillard reactions. Notwithstanding the success of the sulfur dioxide procedure and the relatively long and documented history of its use, some have begun to question the safety of residual sulfur dioxide in fruit packages. For instance, the State of California has considered classifying sulfur dioxide as a reproductive toxin and limits the amount of sulfur dioxide that can be in a fruit package.

Thus, there is a need for a sulfur dioxide absorber that can be used in fruit, and especially dried fruit, packaging.

There is a further need in the art for a composition that can remove sulfur dioxide from a fruit package in a manner that does not allow the later release of the sulfur dioxide.

### BRIEF SUMMARY OF THE INVENTION

A sulfur dioxide reducing composition for reducing the headspace concentration of sulfur dioxide in fruit packages includes a sulfur dioxide absorber having pores sized to retain sulfur dioxide therein and a clinching absorber on the sulfur dioxide absorber with which the sulfur dioxide reacts irreversibly with the sulfur dioxide.

### DETAILED DESCRIPTION OF THE INVENTION

This invention addresses these needs by providing improvements in food packaging in which sulfur dioxide is undesirably present. In one aspect of the invention, a sulfur dioxide absorber includes a sulfur dioxide absorber and a sulfur dioxide clincher on or with the absorber. The absorber attracts and at least temporarily holds sulfur dioxide and the clincher absorber reacts to bind or change the sulfur dioxide so it is not released. An understanding of this and other aspects, features, and benefits of the invention may be had with reference to the following disclosure, in which preferred embodiments of the invention are described.

As noted above, the invention generally relates to reducing sulfur dioxide concentration in food packages. More specifically, the invention relates to removing sulfur dioxide from the headspace of a container, such as a container or package of dried fruit.

In a preferred embodiment, the invention includes a sulfur dioxide reducing composition including an absorber that will releasably retain sulfur dioxide and a clinching absorber that will react with the sulfur dioxide to irreversibly retain the sulfur dioxide. For example, the clinching absorber will react with the sulfur dioxide to convert the sulfur dioxide into another compound that cannot later be released back into the package. In operation, the sulfur dioxide absorber draws the sulfur dioxide into the composition and the clincher absorber reacts with the sulfur dioxide to form a new compound from which sulfur dioxide is not released.

A clinching absorber, as used herein, is in any material that reacts with absorbed sulfur dioxide to change it into a material that will not release sulfur dioxide under ambient storage conditions of about 20° C. The clinching absorber also ordinarily reacts under refrigeration conditions and drying conditions for fruits. The clinching absorbers may further comprise a catalyst to increase the rate of the irreversible reaction that results in formation of a compound that will not emit sulfur dioxide gas.

Four known approaches to reduction of sulfur dioxide concentration in a food package (or any other closed container that contains SO₂):
a) Absorb SO₂ using a suitable absorbent material such as activated carbon or a natural or synthetic zeolite;
b) Absorb SO₂ using a suitable absorbent material and raise the pH so that the SO₂ is converted to the bisulfite (HSO₃⁻) form which cannot revolatilize;
c) Absorb SO₂ using a suitable absorbent material, raise the pH, and then precipitate the resulting bisulfite ion as an insoluble salt such as a calcium salt; or
d) Absorb SO₂ using a suitable absorbent material and then oxidize the SO₂ or bisulfite ion to the sulfate form using a peroxide. The oxidation is irreversible under normal conditions and will absolutely prevent revolatilization of SO₂. However, peroxides are difficult to package and control in the fruit package.

The invention is a method for the irreversible absorption of sulfur dioxide. Activated carbon and other absorbers will absorb sulfur dioxide but the invention formulated an absorber that will react with the sulfur dioxide so that the sulfur dioxide is converted to another compound so that it cannot later be released back into the package. Carbonates react with sulfur dioxide to form a variety of compounds such as sulfates, thiosulfates, polysulfides and elemental sulfur. Lime will react with sulfur dioxide but the reaction is very slow and not that efficient. Magnesium oxide will react with sulfur dioxide to form magnesium sulfate. Alkali metal sulfites will form sulfates. Calcium hydroxide will react with sulfur dioxide to form the insoluble calcium sulfite which will not be converted back to sulfur dioxide. Other hydroxides such as sodium hydroxide or potassium hydroxide will also react with the sulfur dioxide. Calcium chloride will improve the reactivity of the hydroxide with sulfur dioxide. Calcium chloride will react with sulfur dioxide. Potassium iodide will act as a catalyst for the reaction of a hydroxide with sulfur dioxide. Sodium sulfite or sodium hydroxide can be used with lime to react with sulfur dioxide to form calcium sulfite. Copper oxide will react with sulfur dioxide to form copper sulfate. The reaction of moisture impregnated carbon and sulfur dioxide will convert the sulfur dioxide to sulfuric acid inside of the activated carbon. Water impregnated on the activated carbon improves the rate of the sulfur dioxide absorption.

The preferred calcium hydroxide and potassium carbonate were determined to be very fast and efficient at reacting with sulfur dioxide in the gaseous form so that the concentration of sulfur dioxide in the headspace of dried fruit package could be reduced. Other hydroxides and carbonates should also work.

Additional details of how to accomplish each of these SO₂ reduction methods are recited below.

The sulfur dioxide absorbers, as used herein, releasably absorb hydrogen sulfate, but do not substantially react with the sulfur dioxide. They will release the sulfur dioxide when conditions such as temperature, pressure, humidity, pH, or concentration of sulfur dioxide concentration in the air changes. The absorber preferably is a porous structure that allows for retention of the sulfur dioxide in its pores. Absorbers usable in the invention include, but are not limited to, activated carbon and silica gel.

Although in some applications the absorber may be sufficient to remove sulfur dioxide from a headspace of a container, for example, to comply with regulatory requirements for minimum sulfur dioxide concentration, merely adsorbing sulfur dioxide, for example, using activated carbon or the like, can lead to subsequent release of the sulfur dioxide. Thus preferred embodiments of the invention further include a clinching absorber.

The clinching absorber is any substance that will react with or otherwise retain sulfur dioxide in an irreversible manner. For example, the clinching absorber may be a reactive compound. Carbonates, lime, magnesium oxide, alkali metal sulfites, hydroxides, calcium chloride, copper oxide, and water are examples of clinching sulfur dioxide absorbers. Of these, carbonates react with sulfur dioxide to form a variety of compounds such as sulfates, thiosulfates, polysulfides and elemental sulfur. The reaction of lime with sulfur dioxide is quite slow and relatively inefficient and forms calcium sulfite. Magnesium oxide reacts with sulfur dioxide to form magnesium sulfate. Many hydroxides, including calcium hydroxide, sodium hydroxide and potassium hydroxide will react with sulfur dioxide to form a new compound that will not be converted back to sulfur dioxide. For example, calcium hydroxide reacts with sulfur dioxide to form the insoluble calcium sulfite. Water carried by activated carbon will convert the sulfur dioxide to sulfurous acid inside activated carbon.

Sodium sulfite or sodium hydroxide can also be used with lime to react with sulfur dioxide to form calcium sulfite. A catalyst such as potassium iodide or potassium dioxide also may be used.

In preferred embodiments of the invention the clinching absorber is carried on the absorber, such as by being impregnated thereon. As in the example of water and activated carbon given above, the absorber may be carried on the sulfur dioxide absorber by being retained in pores of the absorber.

The sulfur dioxide absorbing composition is preferably contained in a sulfur dioxide permeable container made from a material, such as a film. The film may be a non-woven, spun bonded material, such as that commercially available under the TYVEK® trademark. Such a film preferably is formed into a pouch or sachet and includes the composition described above. Such pouch shapes and methods of making them are conventional. Known non-wovens are also permeable to sulfur dioxide. In each of the Examples discussed below, the formulation was placed in a pouch made of a non-woven like that just described, and the pouch was placed in the vessel from which sulfur dioxide was to be withdrawn.

In another example, the formulations may be provided integral with the film. The formulation may be disposed as part of a laminate structure, for example, between barrier layers. Some formulations may also lend themselves to mixing with thermoplastics, with the mixture thus formed extruded into a film that may be used as packaging for a product from which sulfur dioxide is to be removed.

1.0 gram of potassium carbonate in a Tyvek® packet was placed inside of an 11×16 inch foil barrier pouch containing 7 ounces of golden raisins. After 4 months, the sulfur dioxide content in the headspace of the test package was 7 ppm compared to 40 ppm of sulfur dioxide for the test package without a sulfur dioxide absorber. The sulfur dioxide content was measured by gas chromatography mass spectroscopy. The 1.0 gram of potassium carbonate contained 35,000 ppm (0.35%) sulfur after the 4 months in the test package as measured by inductively coupled argon plasma atomic emission spectroscopy. This reaction with the sulfur dioxide occurred over the 4 months.

1.0 gram of calcium hydroxide in a Tyvek® packet was placed inside of an 11×16 inch foil barrier pouch containing 7 ounces of golden raisins. After 4 months, the sulfur dioxide content in the headspace of the test package was 18 ppm compared to 40 ppm of sulfur dioxide for the test package without a sulfur dioxide absorber. The sulfur dioxide was measured by gas chromatography mass spectroscopy. The 1.0 gram of calcium hydroxide contained 54,000 ppm (0.54%) sulfur after the 4 months in the test package as measured by inductively coupled argon plasma atomic emission spectroscopy. This reaction with the sulfur dioxide occurred over the 4 months.

When 1.0 gram of formulation Mix 1 was tested and then 1.0 gram of formulation Mix 2 was tested which contained twice the amount of potassium carbonate, there was a significant increase in the amount of sulfur dioxide that was absorbed. Formulation Mix 2 contained 19,000 ppm (0.19%) sulfur at the end of the same 4 month test with the 7 ounces of raisins. Formulation Mix 1 contained 48,000 ppm (0.48%) at the end of the 4 month test with the 7 ounces of golden raisins. Both formulations were in Tyvek® packets inside of an 11×16 inch foil barrier pouch containing 7 ounces of golden raisins. These mix formulations were the following:

Mix 1
3.7% potassium carbonate
8.7% water
62.5% activated carbon
25% calcium hydroxide

Mix 2
6.5% potassium carbonate
5.9% water
62.5% activated carbon
25% calcium hydroxide

Mix 3
3.7% potassium carbonate
3.3% water
62.5% activated carbon
30.4% calcium hydroxide

When the amount of calcium hydroxide in formulation Mix 1 was increased by 21.6%, there was a significant increase in the amount of sulfur dioxide that was absorbed. Formulation Mix 2 contained 19,000 ppm (0.19%) sulfur after 4 months with the 7 ounces of raisins. Formulation Mix 3 with a 21.6% increase in the calcium hydroxide content contained 39,000 ppm (0.39%) of sulfur after 4 months with the 7 ounces of raisins. Both formulations were in Tyvek® packets inside of an 11×16 inch foil barrier pouch containing 7 ounces of golden raisins.

All of the above testing was conducted at room temperature. These tests show the effectiveness of the potassium carbonate, calcium hydroxide, and activated carbon in absorbing and binding sulfur dioxide. Activated carbon absorbs the sulfur dioxide; and the potassium carbonate and the calcium hydroxide are clinching materials that bind the sulfur dioxide so that it is not released as a gas.

An equilibrium atmosphere for some dried fruits will include some sulfur dioxide as a gas. Thus, as the sulfur dioxide absorber of the present invention extracts sulfur dioxide from the atmosphere and the clinching absorber reacts with the sulfur dioxide such that it is not readily released, the fruit will give off more sulfur dioxide. Thus, it is desirable that the amount of the sulfur dioxide absorbing composition be chosen to continue to absorb sulfur dioxide beyond an amount originally occurring in the headspace of the container.

In some embodiments of the invention, a preferred reaction shifts the above-mentioned equilibrium in a manner that tends to convert the sulfur dioxide from a volatile, gas form to a stable form that precipitates. Other clinching absorbers are known for, for example, water, carried by carbon or silica gel, will shift the equilibrium, by effecting the following reaction:

SO₂+H₂O⇄H₂SO₃⇄H⁺HSO₃⁻

In another use of clinching material, calcium ions can then be introduced, to precipitate the H⁺ HSO₃− into Ca (HSO₃)₂, a compound from which sulfur dioxide cannot revolatalize. Alternatively, or in addition, a hydroxide can be added to the H⁺ HSO₃− to produce SO₃−−, i.e., sulfite. The sulfite can then be further reacted, for example with calcium ions to create CaSO3, calcium sulfite, which will precipitate out of solution. Other cations, Mg for example, can function similarly if the salt formed is insoluble.

Many formulations for sulfur dioxide absorbers and clinching absorbers that remove sulfur dioxide from atmosphere in a package will be appreciated from the foregoing disclosure. A simple formulation such as water in a carrier will effect a change of sulfur dioxide to sulfurous acid. Adding another clinching absorbent, such as those discussed above, or a precipitant, will cause further reaction of the sulfurous acid in a manner that will irreversibly retain the sulfur dioxide.

The invention finds a preferred use with dried fruit. It is particularly preferred for use with raisins, particularly golden raisins, as it effectively removes sulfur dioxide from the headspace of raisin boxes and also is safe in food packaging as it may be fastened to the inside of the box. Golden raisins have had sulfur dioxide when formed as they start as green grapes and would be the usual dark raisin color if not treated with sulfur dioxide during and/or after drying.

Golden raisins, dried apricots, dried peaches, dried pears, etc. are harvested once per year and are generally gassed with sulfur dioxide while the fruit is fresh, during which time the sulfur dioxide enhances the color. The green grapes are turned yellow or golden and the apricots are turned more orange.

What follows are a number of example formulations that the inventors have created and tested. These are examples only and are in no way limiting of the invention.

### EXAMPLE 1

A three-liter test vessel was evacuated and injected with three liters of gas containing 1,000 ppm of sulfur dioxide in nitrogen. 1 gram of 300-angstrom silica gel containing 15.5% calcium chloride dihydrate and 25.7% water was added to the vessel. This composition reduced the sulfur dioxide content from 1,000 ppm of sulfur dioxide to 1.4 ppm of sulfur dioxide in 96 hours at room temperature. This formulation worked but was slower than some of the other formulations because of the silica gel being used. Activated carbon is better at adsorbing and holding onto organic gases than silica gel. The activated carbon also provides a catalytic effect for the reactions. The water reacts with the sulfur dioxide to form sulfurous acid, which reacts with the calcium chloride to form calcium bisulfite which is irreversible and cannot be revolatized.

### EXAMPLE 2

A three-liter test vessel was evacuated and injected with three liters of gas containing 1,000 ppm of sulfur dioxide in nitrogen. 1 gram of activated carbon containing 12.5% calcium chloride dihydrate and 20.8% water was added to the vessel. This composition reduced the sulfur dioxide content from 1,000 ppm of sulfur dioxide to 0.0 ppm of sulfur dioxide in 24 hours at room temperature.

This formulation with the activated carbon was faster and more efficient than the formulation with the silica gel because the activated carbon with the large surface area of the activated carbon provides a catalytic effect for reactions in addition to the adsorption capability of the activated carbon. The pore structure of the activated carbon has a greater affinity for organic molecules. The large pore structure allows for the greater capacity and the greater strength in holding the organic molecules. The water converts the sulfur dioxide to sulfurous acid and then the calcium chloride reacts to form calcium bisulfite which is irreversible and cannot be revolatized.

### EXAMPLE 3

A three-liter test vessel was evacuated and injected with 1.5-liters of air and 1.5-liters of gas containing 1,000 ppm of sulfur dioxide in nitrogen. 0.05 grams of dry potassium carbonate was added to the vessel. This composition reduced the sulfur dioxide content to 0.7 ppm of sulfur dioxide in 24 hours at room temperature.

### EXAMPLE 4

A three-liter test vessel was evacuated and injected with 1.5-liters of air and 1.5-liters of gas containing 1,000 ppm of sulfur dioxide in nitrogen. 0.05 grams of powdered calcium chloride dihydrate, and 0.4 grams of saturated potassium carbonate were added to the vessel. This composition reduced the sulfur dioxide content to 63 ppm of sulfur dioxide in 96 hours at room temperature.

This reaction was slower due to the fact that the reactants were not on an absorbent such as activated carbon.

### EXAMPLE 5

A three-liter test vessel was evacuated and injected with 1.5-liters of air and 1.5-liters of gas containing 1,000 ppm of sulfur dioxide in nitrogen. 0.05 grams of powdered anhydrous calcium chloride was added to the vessel. This composition reduced the sulfur dioxide content to 62 ppm of sulfur dioxide in 120 hours at room temperature.

This reaction was slower due to the fact that the reactant was not on an absorbent such as activated carbon which would also act as an absorbent. The other factor is that water was not used to convert the sulfur dioxide to sulfurous acid.

### EXAMPLE 6

A three-liter test vessel was evacuated and injected with 1.5-liters of air and 1.5-liters of gas containing 1,000 ppm of sulfur dioxide in nitrogen. 0.4 grams of activated carbon containing 12.5% calcium chloride dihydrate and 20.8% water was added to the vessel. This composition reduced the sulfur dioxide content to 3.0 ppm of sulfur dioxide in 24 hours at room temperature.

This reaction is faster because it has the advantage of the activated carbon to act as an absorbent. The water will convert the sulfur dioxide to sulfurous acid and the calcium chloride will convert this to calcium bisulfite which is now irreversible and cannot be revolatized.

### EXAMPLE 7

A three-liter test vessel was evacuated and injected with 1.5-liters of air and 1.5-liters of gas containing 1,000 ppm of sulfur dioxide in nitrogen. 0.4 grams of activated carbon containing 12.5% anhydrous calcium chloride and 20.8% water was added to the vessel. This composition reduced the sulfur dioxide content to 0.0 ppm of sulfur dioxide in 24 hours at room temperature.

This reaction is faster because it has the advantage of the activated carbon to act as an absorbent. The water will convert the sulfur dioxide to sulfurous acid and the calcium chloride will convert this to calcium bisulfite which is now irreversible and cannot be revolatized.

### EXAMPLE 8

A three-liter test vessel was evacuated and injected with 1.5-liters of air and 1.5-liters of gas containing 1,000 ppm of sulfur dioxide in nitrogen. 0.05 grams of anhydrous potassium carbonate in .05 grams of water for a total of 0.1 grams was added to the vessel. This composition reduced the sulfur dioxide content to 0.0 ppm of sulfur dioxide in 24 hours at room temperature. Potassium carbonate is very efficient in reacting with sulfur dioxide to convert the sulfur dioxide to potassium sulfate. This is another reaction that is irreversible where the sulfur dioxide cannot be revolatized at another time. The reaction could have been even faster if activated carbon had been used.

### EXAMPLE 9

A three-liter test vessel was evacuated and injected with 1.5-liters of air and 1.5-liters of gas containing 1,000 ppm of sulfur dioxide in nitrogen. 0.75 grams of activated carbon impregnated with 20% water and dried mangoes were added to the vessel. This composition reduced the sulfur dioxide content to 0.0 ppm of sulfur dioxide in 24 days at room temperature. The water converted the sulfur dioxide to sulfur acid. The activated carbon also adsorbs sulfur dioxide. The reason that it took longer for the sulfur dioxide content to be reduced to 0.0 ppm is that the dried mangoes were liberating sulfur dioxide in the test vessel during this time. The mangoes liberate less sulfur dioxide than raisins.

### EXAMPLE 10

A three-liter test vessel was evacuated and injected with 1.5-liters of air and 1.5-liters of gas containing 1,000 ppm of sulfur dioxide in nitrogen. 0.05 grams of potassium carbonate dissolved in 0.05 grams of water and impregnated on 0.65 grams of activated carbon (for a total weight of 0.75 grams) and dried mangoes were added to the test vessel. This composition reduced the sulfur dioxide content to 1.0 ppm of sulfur dioxide in 24 days at room temperature. The water converted the sulfur dioxide to sulfurous acid and the potassium carbonate converted the sulfur dioxide to potassium sulfate. The activated carbon also adsorbs the sulfur dioxide and has a catalytic effect on the reactions. The reason that it took longer to bring the sulfur dioxide content down is that the dried mangoes continued to liberate sulfur dioxide. The mangoes liberate less sulfur dioxide than raisins.

### EXAMPLE 11

A three-liter test vessel was evacuated and injected with 1.5-liters of air and 1.5-liters of gas containing 1,000 ppm of sulfur dioxide in nitrogen. 0.1 gram of anhydrous potassium carbonate powder and dried peaches were added to the vessel. This composition reduced the sulfur dioxide content to 1.1 ppm of sulfur dioxide in 24 days at room temperature. The potassium carbonate is an efficient reactant for the sulfur dioxide converting the sulfur dioxide to potassium sulfate but the dried peaches continued to liberate sulfur dioxide overtime. This is the reason for the 24 days. Activated carbon would have improved the reactivity and adsorption of the sulfur dioxide.

### EXAMPLE 12

A three-liter test vessel was evacuated and injected with 1.5-liters of air and 1.5-liters of gas containing 1,000 ppm of sulfur dioxide in nitrogen. 0.3 grams of Jacobi VA2 activated carbon and jumbo raisins were added to the test vessel. This composition reduced the sulfur dioxide content to 2.0 ppm of sulfur dioxide in 21 days at room temperature. This specialty activated carbon is impregnated with reactants when manufactured to adsorb and react with the sulfur dioxide. This reaction is irreversible. This specialty activated carbon is a very fast absorber for sulfur dioxide. The raisins liberate more sulfur dioxide overtime than most other dried fruits, this is the reason for the 21 days.

### EXAMPLE 13

A three-liter test vessel was evacuated and injected with 1.5-liters of air and 1.5-liters of gas containing 1,000 ppm of sulfur dioxide in nitrogen. 0.32 grams of a combination of 1 5.5% anhydrous calcium chloride, 25.7% water, 58.8% 300-angstrom silica gel and jumbo raisins were added to the test vessel. This composition reduced the sulfur dioxide content to 3.7 ppm of sulfur dioxide in 21 days at room temperature. This is a good absorber formulation for sulfur dioxide but the formulation might have been faster if activated carbon had been used in place of the 300 angstrom silica gel because of the preferable adsorptive catalytic effect of the activated carbon. The water converts the sulfur dioxide to sulfurous acid and the calcium chloride reacts to form calcium bisulfite which is irreversible. The reason that this was slower is that the raisins liberate sulfur dioxide overtime. Dried raisins liberate more sulfur dioxide than most other dried fruits.

### EXAMPLE 14

A three-liter test vessel was evacuated and injected with 1.5-liters of air and 1.5-liters of gas containing 1,000 ppm of sulfur dioxide in nitrogen. 0.4 grams of a combination of 12.5% anhydrous calcium chloride, 20.8% water, 66.7% activated carbon and golden raisins were added to the test vessel. This composition reduced the sulfur dioxide content to 8.8 ppm of sulfur dioxide in 21 days at room temperature. This is a good sulfur dioxide absorber formulation. The water converts the sulfur dioxide to sulfurous acid and the calcium chloride reacts to form calcium bisulfite which is irreversible. The golden raisins liberate more sulfur dioxide overtime than any other dried fruit.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A sulfur dioxide reducing composition for reducing the headspace concentration of sulfur dioxide in fruit packages comprising:
a sulfur dioxide absorber having pores sized to retain sulfur dioxide therein; and
a clinching absorber on the sulfur dioxide absorber with which the sulfur dioxide reacts irreversibly.

2. The sulfur dioxide reducing composition of claim 1, wherein the sulfur dioxide absorber is selected from a group consisting of carbon, silica gel, and zeolite.

3. The sulfur dioxide reducing composition of claim 1, wherein the clinching absorber is selected from the group consisting of a carbonate, lime, magnesium oxide, an alkali metal sulfite, a hydroxide, and calcium chloride.

4. The sulfur dioxide reducing composition of claim 3, wherein the clinching absorber is a hydroxide and the hydroxide is selected from the group consisting of calcium hydroxide, sodium hydroxide, potassium hydroxide, and mixtures thereof.

5. The sulfur dioxide reducing composition of claim 1, wherein the sulfur dioxide absorber has a pore size of at least 100 angstroms.

6. The sulfur dioxide reducing composition of claim 5, wherein the sulfur dioxide absorber has a pore size of at least 200 angstroms.

7. The sulfur dioxide reducing composition of claim 6, wherein the sulfur dioxide absorber has a pore size of at least 300 angstroms.

8. The sulfur dioxide reducing composition of claim 1, wherein the irreversible reaction of the clinching absorber is a chemical reaction.

9. The sulfur dioxide reducing composition of claim 1, further comprising a catalyst for the irreversible reaction.

10. The sulfur dioxide reducing composition of claim 9, wherein the catalyst is potassium dioxide or potassium iodide.

11. The sulfur dioxide reducing composition of claim 1, wherein the sulfur dioxide absorber comprises moisture impregnated carbon.

12. The sulfur dioxide reducing composition of claim 1, wherein the clinching absorber comprises potassium carbonate or calcium hydroxide.

13. A package comprising:
a sulfur dioxide permeable material containing the sulfur dioxide reducing composition of claim 1.

14. The package of claim 13 formed as a sachet.

15. A method of absorbing sulfur dioxide from a package comprising:
depositing a predetermined amount of a sulfur dioxide absorber carrying a clinching absorber in a sulfur dioxide permeable film; and
positioning the sulfur dioxide permeable film in contact with a headspace comprising sulfur dioxide.

16. The method of claim 15, wherein the depositing step comprises depositing the predetermined amount of sulfur dioxide absorber carrying a clinching absorber in a sachet formed from the sulfur dioxide permeable film.

17. A fruit package comprising:
a fruit previously treated with sulfur dioxide;
an outer package substantially impermeable to sulfur dioxide; and
a sulfur dioxide reducing composition as set forth in claim 1 in the outer package.
